(19) United States
(12) Patent Application Publication
(10) Pub. No.: US 2008/0267692 A1
(43) Pub. Date: Oct. 30, 2008

(54) Friction Coupling, Friction Assembly and Press Table Comprising a Friction Coupling, and a Method

(76) Inventor: Jens Soderlund, Vadstena (SE)

Correspondence Address: HARNESS, DICKEY & PIERCE, P.L.C., P.O. BOX 8910, RESTON, VA, 20195, US

(21) Appl. No.: 11/596,855

(22) PCT Filed: May 6, 2005
(86) PCT No.: PCT/SE05/00653

§ 371 Date: Mar. 24, 2008

(30) Foreign Application Priority Data
May 18, 2004 (SE) 0401289-4

(51) Int. Cl. B23B 31/30; F16J 1/06; B30B 1/08

(52) U.S. Cl. 403/5; 92/203; 100/270

(57) ABSTRACT

A friction coupling for friction locking of a shaft relative to a hub, comprises a radially deformable inner sleeve, a substantially dimensionally stable outer sleeve and at least one pressure chamber defined by at least the inner sleeve and the outer sleeve. The inner sleeve is arranged to be radially deformed, thereby producing a surface pressure on the shaft, for friction locking of the shaft relative to the hub. Measuring means integrating with the outer sleeve is arranged to measure the strain of the outer sleeve, which strain is an indication of the friction locking. The above-described friction coupling can be used, for instance, in piston assemblies and press tables.

### FIELD OF THE INVENTION

The present invention relates to a friction coupling according to the preamble to claim 1, applications of such a friction coupling according to the preamble to claims 9 and 11, respectively, and a method for determining the friction locking of a friction coupling according to the preamble to claim 13.

### BACKGROUND ART

A large number of variants of friction couplings are known. Examples of prior-art friction couplings are disclosed in WO04/007129 and SE-511,085.

A friction coupling usually comprises a relatively thin, radially deformable inner sleeve and a substantially dimensionally stable outer sleeve. One type of friction coupling comprises a pressure chamber which is filled with a pressurisable medium, in which, when pressurising the medium, a force is produced between the outer sleeve and the inner sleeve, whereby the inner sleeve is deformed, so that a surface pressure arises between the inner circumferential surface of the inner sleeve and a shaft surrounded by the inner sleeve. The shaft is fixed relative to the inner sleeve by the frictional force that arises between the inner sleeve and the shaft owing to the surface pressure, thus allowing transfer of torque and/or force.

Friction couplings can be used in various fields. It can be used as a coupling between a shaft and a hub, where the outer sleeve is fixed to the hub and the inner sleeve engages the shaft by friction. Another example is a tool holder (chuck) in machine tools, where the outer sleeve is fixed to the rotary part of the machine tool and the inner sleeve engages the tool by friction.

Friction couplings can, however, also be used as safety locks, for instance in hydraulic or pneumatic cylinders, in which case the shaft of the cylinder is locked relative to the cylinder body, and thus prevent the cylinder from being unintentionally actuated, for instance in transport or maintenance. This type of safety lock can thus be applied in various machines, such as excavators, hoisting cranes, hydraulic presses etc.

When a friction coupling is used as a safety lock, it is important to ensure that it has been actuated correctly since there may otherwise be a risk of individuals being injured and/or property being damaged.

A known way of ensuring that a friction coupling has been correctly actuated is to measure, by means of a sensor, a movement in the axial direction between an outer sleeve and an inner sleeve. A drawback of this type of measuring is, however, the sensitivity to wear on the parts included in the friction coupling. In an extreme case, the complete absence of a shaft may be indicated as if the friction coupling is locked.

There is thus a need for an improved or alternative friction coupling, which allows correct friction locking to be ensured.

### SUMMARY OF THE INVENTION

The object of the present invention is to provide a friction coupling, which makes it possible to ensure that this has been correctly actuated. A further object is to provide a method for ensuring that a friction coupling has been correctly actuated. Additional objects comprise providing a piston assembly with a safety lock and a press table for use in a press.

The objects are wholly or partly achieved by a friction coupling, a method, a piston assembly and a press table according to the respective independent claims. Embodiments will be evident from the dependent claims and from the following description and the drawings.

In a first aspect, a friction coupling is thus provided for friction locking of a shaft relative to a hub, comprising a radially deformable inner sleeve, a substantially dimensionally stable outer sleeve, and at least one pressure chamber defined by at least the inner sleeve and the outer sleeve, the inner sleeve being arranged to be radially deformed, thereby producing a surface pressure on the shaft, for friction locking of the shaft relative to the hub.

The friction coupling is characterised in that measuring means integrated with the outer sleeve is arranged to measure the strain of the outer sleeve, which strain is an indication of said friction locking.

“Shaft” and “hub” are schematic designations. By “hub” is here meant any machine element. By “shaft” is correspondingly meant a machine element of any cross-section, which in its non-locked state can perform an axial and/or rotary movement relative to the hub.

By “substantially dimensionally stable” is meant that the outer sleeve is designed and dimensioned so as to substantially keep its shape as the friction coupling is actuated, and thus function as an abutment for the inner sleeve, but yet has such elastic properties that it is slightly strained in actuation of the friction coupling.

By “pressure chamber” is meant a space which in pressurisation affects the actuation of the friction coupling.

By “strain” is in the first place meant the radial and/or tangential strain of the outer sleeve.

By arranging a measuring means in the manner described above it is possible to obtain an indirect indication that the friction coupling has been correctly actuated. Since the strain of the outer sleeve arises as a necessary consequence of the deformation of the inner sleeve producing a pressure between the inner sleeve and the shaft, the measuring means will be insensitive to wear on the parts of the friction coupling. This enables an indication whether a sufficient locking force has been achieved or not, optimisation of locking force, for instance for the purpose of minimising the load on the friction coupling and controlling the process in locking and/or unlocking.

In a second aspect, a piston assembly is provided, comprising a cylinder, an axially movable piston arranged in the cylinder, a piston shaft connected to the piston and projecting from the cylinder. The piston assembly is characterised by a friction coupling as described above, a sleeve of the friction coupling being fixed relative to the cylinder and the friction coupling being designed to engage the piston shaft for friction locking of the piston shaft relative to the cylinder.

In a third aspect, a press table for use in a press is provided, said press table comprising a support which is movable relative to a shaft. The press table is characterised by a friction coupling as described above, a sleeve of the friction coupling being fixed relative to the support and the friction coupling being designed to engage the shaft for friction locking of the support relative to the shaft.

In a fourth aspect, a method for determining the friction locking of a friction coupling is provided, said friction coupling comprising a radially deformable inner sleeve, a substantially dimensionally stable outer sleeve, and at least one pressure chamber defined by at least the inner sleeve and the outer sleeve. The method comprises measuring the strain of the outer sleeve by a measuring means integrated with the outer sleeve, and based on the measured strain, providing an indication of said friction locking.

Examples of embodiments will now be described in more detail with reference to the accompanying drawings.

### BRIEF DESCRIPTION OF THE DRAWINGS

FIG. 1 is a schematic sectional view of a friction coupling according to a first embodiment.

FIG. 2a is a schematic sectional view of a part of an outer sleeve of the friction coupling shown in FIG. 1 in a first embodiment.

FIG. 2b is a schematic sectional view of a part of an outer sleeve of the friction coupling shown in FIG. 1 in a second embodiment.

FIG. 3 is a schematic sectional view of a part of an outer sleeve of the friction coupling shown in FIG. 1.

FIG. 4 is a schematic sectional view of a friction coupling according to a second embodiment.

FIG. 5 is a schematic sectional view of a part of a friction coupling according to a third embodiment.

FIG. 6 is a schematic perspective view of a piston assembly comprising a friction coupling.

FIG. 7 is a schematic perspective view of a press table comprising friction couplings.

FIG. 8 is a schematic sectional view of a friction coupling according to a fourth embodiment.

### DESCRIPTION OF EMBODIMENTS

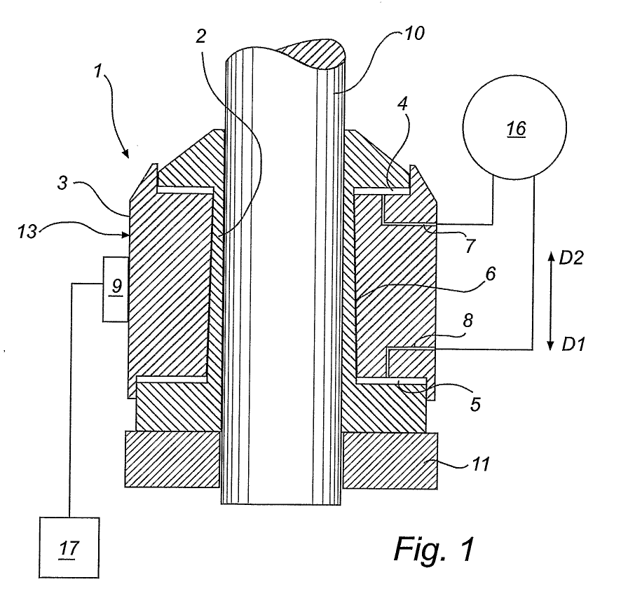

FIG. 1 is a schematic sectional view of a friction coupling 1 according to a first embodiment. In the example illustrated in FIG. 1, the friction coupling 1 is adapted to connect a schematically indicated shaft 10 to a schematically indicated hub 11. The outer sleeve 3 and the inner sleeve 2 have cooperating conical surfaces 9, which in axial movement of the outer sleeve 3 on the inner sleeve 2 perform a compression of the inner sleeve 2, so that a surface pressure, or a clamping locking force between the inner sleeve 2 and the shaft 10, is produced. The surface pressure/locking force causes a frictional force between the inner circumferential surface of the inner sleeve 2 and the surface of the shaft, thus allowing frictional transfer of torque and/or force.

The axial movement is performed by a first pressure chamber 4, which is defined by the outer sleeve 3 and the inner sleeve 2, and which is positioned at one end of the friction coupling 1, being pressurised so that the outer sleeve is moved in the direction which in FIG. 1 is designated D1. Pressurisation is performed by a pressure source 16, for instance a hydraulic or pneumatic pump, being connected via a first duct 7 communicating with the first pressure chamber 4.

When the friction coupling 1 is to be released, a second pressure chamber 5 is pressurised, which is positioned at the other end of the friction coupling 1, so that the outer sleeve 3 is moved in the direction which in FIG. 1 is designated D2, and which is opposite to the direction D1. The pressurisation of the second pressure chamber 5 can be provided in the same way as the pressurisation of the first pressure chamber 4, i.e. by a pressure source being connected to a second duct 8 communicating with the second pressure chamber 5.

In one embodiment, a sensor 9 may consist of a strain gauge which is arranged on a peripheral surface 13 of the friction coupling 1. The strain gauge 9 can be arranged to measure the tangential and/or radial strain of the outer sleeve 3, which is proportional to a surface pressure between the inner sleeve 2 and the shaft 10. The frictional force, i.e. the force to be transferred by the friction coupling, that arises between the inner sleeve 2 and the shaft 10 is in turn proportional to the surface pressure, which makes it possible to determine the size of the frictional force by measuring the strain of the outer sleeve.

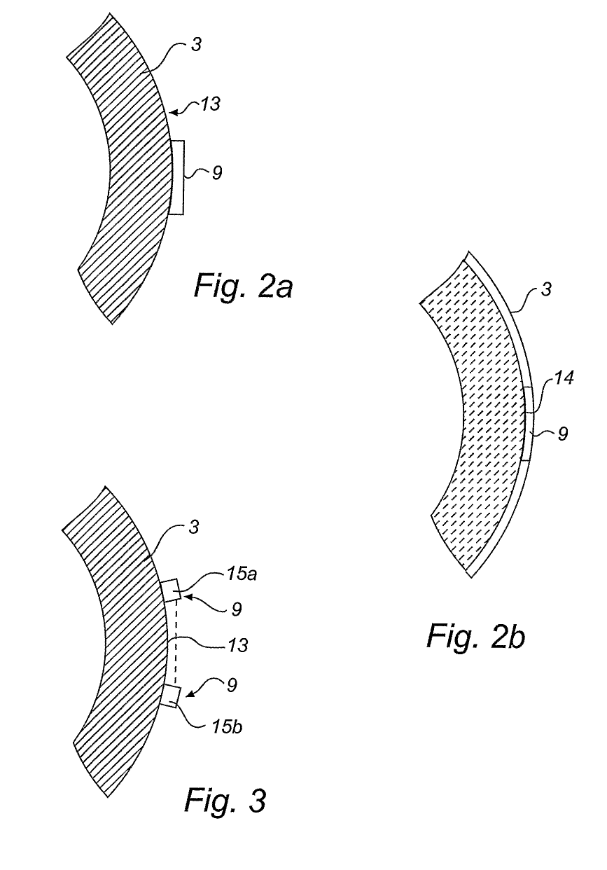

FIG. 2a is a schematic sectional view, perpendicular to the shaft 10 in FIG. 1, of a part of an outer sleeve of the friction coupling shown in FIG. 1 in a first embodiment. As shown in FIG. 2a, the strain gauge 9 can have a relatively small extent along the circumference of the outer sleeve 3.

FIG. 2b is a schematic sectional view, perpendicular to the shaft 10 in FIG. 1, of a part of an outer sleeve of the friction coupling shown in FIG. 1 in a second embodiment. As shown in FIG. 2b, the strain gauge 9 can be arranged in a slot 14 in the surface 13 of the outer sleeve 3, said slot 14 extending along substantially the entire periphery of the outer sleeve.

In other embodiments, which are not described in more detail, the strain gauge may consist of an optical fibre, piezoelectric elements or the like.

FIG. 3 illustrates an alternative embodiment, where the sensor 9 consists of a distance meter 15a, 15b, which is arranged to measure, for instance in an optical manner, a distance between two points on the surface 13 of the outer sleeve.

The sensor 9 can be connected to a measuring instrument 17, which can be arranged to receive a signal from the sensor 9 and, based on the signal, provide an indication of the surface pressure, and thus the force that exists between the inner sleeve 2 and the shaft 10. In one embodiment, the measuring instrument 17 can be arranged to compare the indication with a predetermined value, which is considered to indicate whether there is a safe coupling. The measuring instrument can also be arranged to give a user or control/regulating equipment (not shown) an indication whether there is a safe coupling.

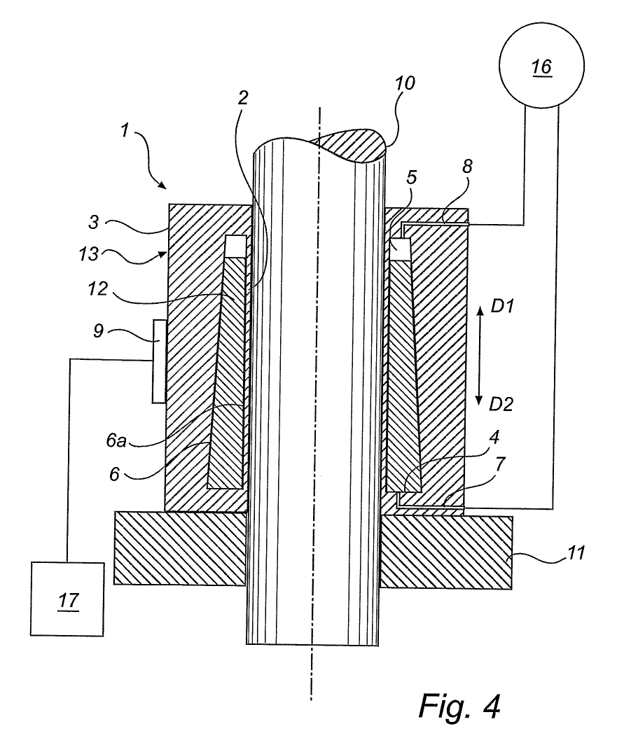

FIG. 4 is a schematic sectional view of a friction coupling according to a second embodiment. In the second embodiment, the inner sleeve 2 and the outer sleeve 3 are fixedly arranged relative to each other, for instance by welding or screws, so that a closed space is formed between the inner sleeve 2 and the outer sleeve 3. An intermediate sleeve 12 is arranged in this closed space. The intermediate sleeve 12 is designed to cooperate with the inner sleeve 2 on the one hand and the outer sleeve 3 on the other, by at least one conical surface 6, 6a, the intermediate sleeve being movable in an axial direction relative to the inner sleeve 2 and the outer sleeve 3. By moving the intermediate sleeve 12 in the direction which is designated D1 in FIG. 4, a compression of the inner sleeve 2 is performed, so that a clamping force arises between the inner sleeve 2 and the shaft 10.

The movement of the intermediate sleeve 12 relative to the inner sleeve 2 and the outer sleeve 3 is performed by the respective pressure chambers 4, 5, which via the respective ducts 7, 8 are pressurised by means of a pressure source 16.

The function of the friction coupling shown in FIG. 4 is thus analogous to the function of the friction coupling shown in FIG. 1.

As shown in FIG. 4, a sensor 9 can be arranged on an outer surface 13 of the friction coupling 1, which sensor is connected to a measuring instrument in the manner described above.

The friction couplings shown in FIG. 1 and FIG. 4 can be designed in such a manner that their conical surfaces 6, 6a have sufficient friction to be self-locking, which gives the advantage that the pressure source need only be connected during locking and unlocking of the friction coupling.

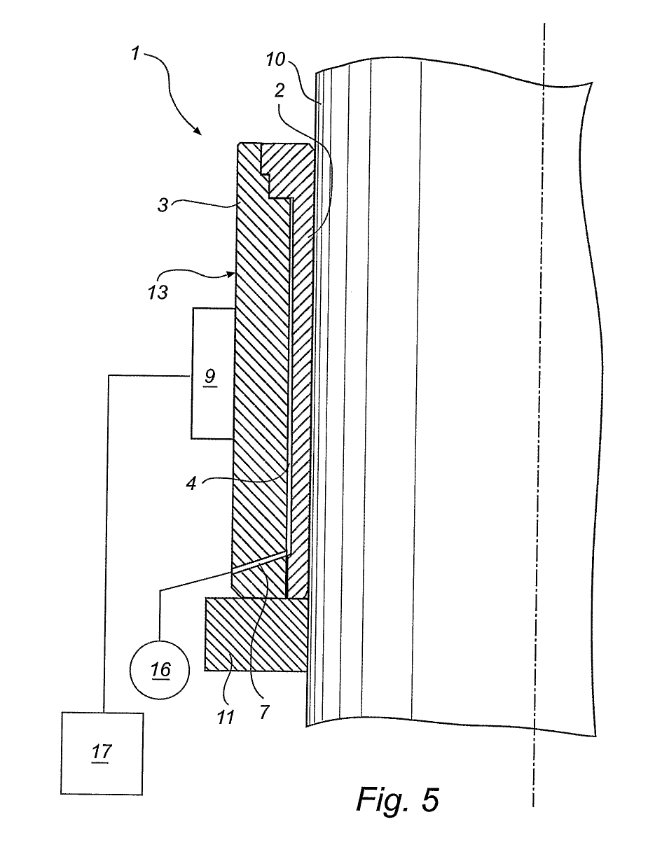

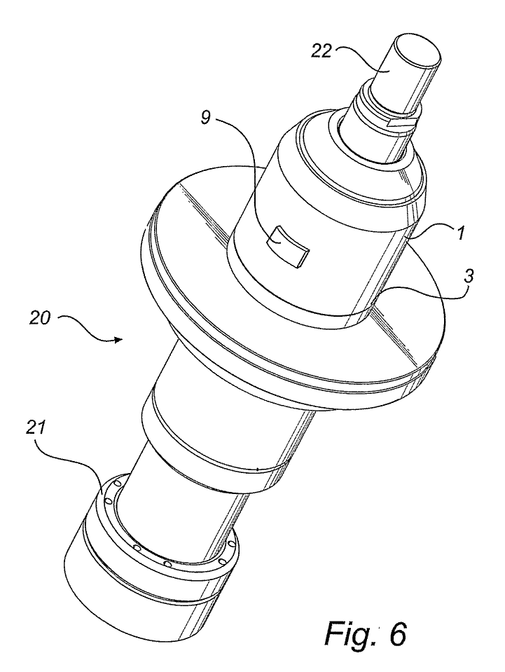

FIG. 5 is schematic sectional view of a part of a friction coupling according to a third embodiment. In this embodiment, the friction coupling 1 consists of radially deformable inner sleeve 2 and a substantially dimensionally stable outer sleeve 3, a pressure chamber 4 being arranged between the inner sleeve and the outer sleeve, so that the main boundary surfaces of the pressure chamber consist of the outer circumferential surface of the inner sleeve 2 and the inner circumferential surface of the outer sleeve 3. The friction coupling in FIG. 5 is actuated by the pressure chamber 4 being pressurised, and is deactuated by the pressure in the pressure chamber being reduced. In the embodiment shown in FIG. 5, the pressure chamber 4 must be pressurised when the friction coupling has been actuated.

As shown in FIG. 5, a sensor 9 can be arranged on an outer surface 13 of the friction coupling 1, which sensor is connected to a measuring instrument in the manner described above. It will also be appreciated that it is possible to verify the friction locking of the friction coupling shown in FIG. 5 by direct measuring of the pressure in the pressure chamber.

FIG. 6 is a schematic perspective view of a piston assembly 20 comprising a friction coupling.

The piston assembly comprises a cylinder 21, in which a piston (not shown) is axially movable and connected to a shaft 22, which projects from the cylinder 21.

According to a first embodiment (FIG. 6), the shaft 22 can project from one end of the cylinder, the other end of the cylinder being closed. According to a second embodiment (not shown), the shaft can project from both ends of the cylinder, i.e. the cylinder is a two-way cylinder. The piston assembly can be, for instance, a hydraulic piston or a pneumatic piston.

Adjacent to that part of the cylinder 21 where the shaft projects, a friction coupling 1 according to one of the embodiments described above is arranged. The outer sleeve 3 of the friction coupling is connected to the cylinder 21, for example by means of screws. The inner sleeve 2 of the friction coupling is, in terms of diameter, adjusted to the shaft 22, so that when the friction coupling 1 is deactuated (unlocked) there is only little friction, or no friction at all, between the outer surface of the shaft and the inner circumferential surface of the inner sleeve 2 of the friction coupling 1. As the friction coupling 1 is actuated, an axial friction locking of the shaft 22 relative to the cylinder 21 is provided. By reading the measuring means 9, as described above, it is possible to determine whether the friction locking between the cylinder and the shaft is sufficient.

According to one embodiment, the piston assembly is a hydraulic piston, which can be actuated by hydraulic liquid supplied by a pressure source, which can, but need not, be identical with the pressure source 17.

According to another embodiment, the piston assembly is a pneumatic piston, which can be actuated by gas supplied by a pressure source.

According to a third embodiment, the piston assembly is a gas spring, the resilient element being a gas-filled chamber, for which the piston constitutes a boundary surface.

According a fourth embodiment, the piston assembly is a mechanical spring, the resilient element being a coil spring for instance.

According to a fifth embodiment, the piston assembly is a non-actuatable telescopic support, which only serves as a support and/or has a guiding effect.

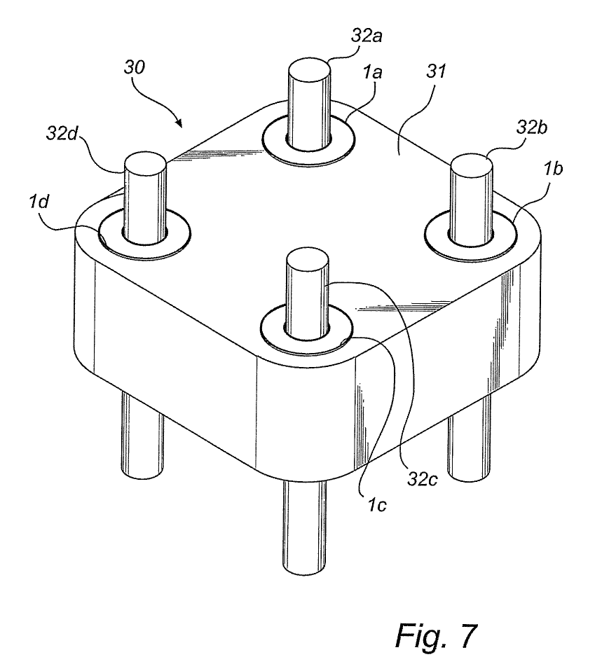

FIG. 7 is a perspective schematic view of a press table 30 comprising friction couplings 1a, 1b, 1c, 1d. The press table 30 can be used, for instance, in a hydraulic press (not shown), a pneumatic press (not shown) or an eccentric press (not shown), to support a mould (not shown) and/or a workpiece (not shown). In the embodiment shown in FIG. 7, the press table consists of a support 31 which forms a supporting surface. It will be appreciated that the support 31 is schematically shown as a plane horizontal surface, but in an application may have any shape and extent. The support 31 is movably suspended from four shafts 32a, 32b, 32c, 32d. The support 31 is lockable in a desired position relative to the shafts 32a, 32b, 32c, 32d by means of respective friction couplings 1a, 1b, 1c, 1d. Each of these friction couplings 1a, 1b, 1c, 1d is arranged so that a sleeve, i.e. the inner sleeve in FIGS. 1, 5 or the outer sleeve in FIG. 4, is fixed to the support, and so as to allow engagement with the respective shafts 32a, 32b, 32c, 32d.

By actuating the friction couplings 1a, 1b, 1c, 1d, the support 31 is locked relative to the shafts 32a, 32b, 32c, 32d. By the measuring means 9 (FIGS. 1, 4, 5), an indication is provided that each of the friction couplings is correctly locked and that the press table is safe to use.

In one embodiment, the friction couplings 1a, 1b, 1c, 1d are arranged to be actuated and released substantially simultaneously.

It will be appreciated that the friction couplings can be used either to perform friction locking of the press table during the work cycle or for safety locking of the press table in connection with maintenance and/or change of tools.

Arrangements like those described with reference to FIG. 6 and FIG. 7 can be used in connection with rotary as well as axially movable shafts, as transport locks, for instance for machines with hydraulic cylinders, for holding moulds together in moulding tools or injection moulding devices.

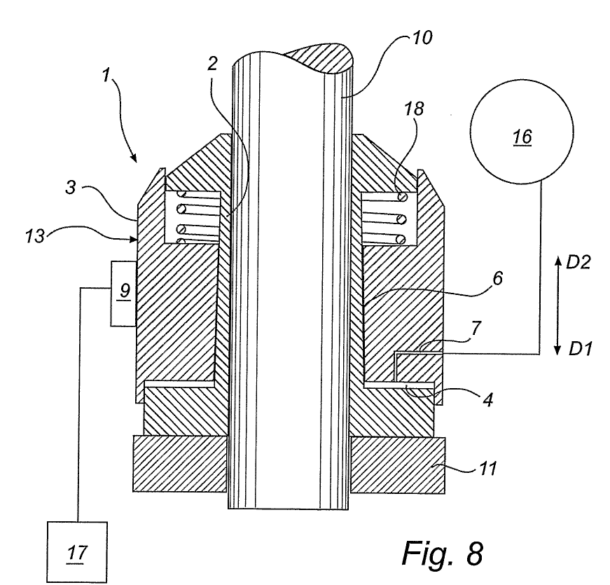

FIG. 8 shows another embodiment of a friction coupling 1. The friction coupling shown in FIG. 8 functions largely as the friction coupling shown in FIG. 1, except that a spring element 18 is arranged to produce the force that causes the outer sleeve 3 to be moved in the direction D1 and thus perform friction locking of the shaft 10 relative to the hub 11. Furthermore a pressure chamber 4 is arranged to produce a force counteracting the spring element 18, so that deactuation, i.e. unlocking, of the friction coupling is made possible. The spring element can be of any type, for instance a coil spring, a cup spring, an elastic material, such as rubber or the like, or a gas spring.

1. A friction coupling for friction locking of a shaft relative to a hub, comprising
a radially deformable inner sleeve,
a substantially dimensionally stable outer sleeve, and
at least one pressure chamber defined by at least the inner sleeve and the outer sleeve,
the inner sleeve being arranged to be radially deformed, thereby producing a surface pressure on the shaft, for friction locking of the shaft relative to the hub,
wherein
measuring means integrated with the outer sleeve is arranged to measure the strain of the outer sleeve, which strain is an indication of said friction locking.

2. A friction coupling as claimed in claim 1, wherein said measuring means comprises a strain gauge.

3. A friction coupling as claimed in claim 1, wherein said measuring means comprises an optical distance meter, which is arranged to measure the distance between two angularly spaced-apart points on the surface of the outer sleeve.

4. A friction coupling as claimed in claim 1, wherein the inner sleeve is arranged to be radially deformed in response to a pressure increase in the pressure chamber, for friction locking of the shaft relative to the hub.

5. A friction coupling as claimed in claim 4, wherein the inner sleeve and the outer sleeve are movable relative to each other in an axial direction and have a cooperating conical surface, which is designed to deform the inner sleeve in said movement, so that the friction locking is performed, and
wherein at least one pressure chamber comprises a first pressure chamber which, for performing the friction locking, is arranged to move the outer sleeve relative to the inner sleeve in a first axial direction, and a second pressure chamber, which, for the friction locking to cease, is arranged to move the outer sleeve relative to the inner sleeve in a second axial directions.

6. A friction coupling as claimed in claim 4, wherein said inner sleeve and outer sleeve are fixed relative to each other, and wherein said friction coupling further comprises an intermediate sleeve which is axially movable relative to the outer sleeve and the inner sleeve, the intermediate sleeve having a conical surface which cooperates with the inner sleeve and/or the outer sleeve and which is designed to deform the inner sleeve in said movement, so as to perform the friction locking, and
wherein said at least one pressure chamber comprises a first pressure chamber, which to perform the friction locking is arranged to move the intermediate sleeve relative to the outer sleeve and the inner sleeve in a first axial direction, and a second pressure chamber, which, for the friction locking to cease, is arranged to move the intermediate sleeve relative to the outer sleeve and the inner sleeve in a second axial direction.

7. A friction coupling as claimed in claim 4, wherein said inner sleeve and outer sleeve are fixed relative to each other, said pressure chamber being substantially defined by a gap between an inner circumferential surface of the outer sleeve and an outer circumferential surface of the inner sleeve, the inner sleeve being designed to be deformed as the pressure chamber is being pressurised.

8. A friction coupling as claimed in claim 1, wherein the inner sleeve and the outer sleeve are movable relative to each other in an axial direction and have a cooperating conical surface, which is designed, when being moved in a first axial direction, to deform the inner sleeve, so as to perform the friction locking,
wherein a spring element is arranged to provide said movement in said first axial direction, and
wherein a pressure chambers, for the friction locking to cease, is arranged to move the outer sleeve relative to the inner sleeve in a second axial direction.

9. A piston assembly comprising a cylinder, an axially movable piston arranged in the cylinder, a piston shaft connected to the piston and projecting from the cylinder, characterised by a friction coupling as claimed in claim 1, a sleeve of the friction coupling being fixed relative to the cylinder and the friction coupling being designed to engage the piston shaft for friction locking of the piston shaft relative to the cylinder.

10. A piston assembly as claimed in claim 9, further comprising an actuating means acting between the cylinder and the piston to provide an axial movement of the piston relative to the cylinder, said actuating means being selected from a group consisting of
a spring element,
a gear rack, and
a substantially closed chamber comprising a pressurisable medium.

11. A press table for use in a press, said press table comprising a support which is movable relative to a shaft, characterised by a friction coupling as claimed in claim 1, a sleeve of the friction coupling being fixed relative to the support and the friction coupling being designed to engage the shaft for friction locking of the support relative to the shaft.

12. A press table as claimed in claim 11, wherein the support is movable relative to at least two shafts which are arranged substantially parallel to the main pressing direction of the press, and wherein the support is lockable relative to the two shafts by means of an associated friction coupling.

13. A method for determining the friction locking of a friction coupling, said friction coupling comprising
a radially deformable inner sleeve,
a substantially dimensionally stable outer sleeve, and
at least one pressure chamber defined by at least the inner sleeve and the outer sleeve, said method comprising
measuring the strain of the outer sleeve by a measuring means integrated with the outer sleeve, and
based on the measured strain, providing an indication of said friction locking.

14. A method as claimed in claim 13, further comprising comparing said indication with a predetermined value,
if the indication exceed the predetermined value, indicating that the friction locking is approved, and
if the indication falls below the predetermined value, indicating that the friction locking is not approved.
